(19) United States
(12) Patent Application Publication
(10) Pub. No.: US 2025/0016153 A1
(43) Pub. Date: Jan. 9, 2025

(54) SYSTEMS AND METHODS FOR LINKING VERIFICATION OF ATTRIBUTES IN CONNECTION WITH NETWORK TRAFFIC

(71) Applicant: MASTERCARD INTERNATIONAL INCORPORATED, PURCHASE, NY (US)

(72) Inventors: Mouly Kuchipudi, Chesterfield, MO (US); Anand Reddy Mallepally, Chesterfield, MO (US); Craig Alan Gilbert, Chesterfield, MO (US); Fernand Collart, Courriére (BE); Michael James Shaon, Columbia, MO (US); Carsten Muerl, Schoeneck (DE)

(21) Appl. No.: 18/762,503

(22) Filed: Jul. 2, 2024

Related U.S. Application Data
(60) Provisional application No. 63/524,823, filed on Jul. 3, 2023.

(51) Int. Cl. H04L 9/40

(52) U.S. Cl. CPC H04L 63/0861; H04L 63/10

(57) ABSTRACT

Systems and methods are provided for verifying attributes of users in connection with network interactions involving the users. An example computer-implemented method includes receiving an authentication request (AReq) in connection with an interaction related to an age-restricted product, where the AReq includes an account number for a user and an age verification signal. The method also includes, in response to the age verification signal, retrieving a birthdate of the user, determining an age of the user based on the birthdate of the user, and determining the age of the user satisfies a defined threshold. The method then includes, in response to the age of the user satisfying the defined threshold, causing a challenge question to be issued to the user, whereby authentication of the user is initiated through a mobile device of the user.

### CROSS-REFERENCE TO RELATED APPLICATION

This application claims the benefit of, and priority to, U.S. Provisional Application No. 63/524,823, filed Jul. 3, 2023. The entire disclosure of the above application is incorporated herein by reference.

### FIELD

The present disclosure generally relates to systems and methods for use in linking verification of attributes in connection with network traffic.

### BACKGROUND

This section provides background information related to the present disclosure which is not necessarily prior art.

Users are known to interact with different entities, through networks, for a variety of reasons. From time to time, as part of the interactions, the entities desire to authenticate the users to confirm identities of the users, for example, to ensure the users are the correct users, as compared to different users claiming to be the users, etc.

Specifically, in the context of transactions, users may be authenticated to inhibit and/or prevent fraudulent or unauthorized transactions. For example, EMV technology has been employed to authenticate users in connection with certain transactions, where chips included in cards cooperate with terminals to generate cryptograms for the transactions, which are then validated prior to approval of the transactions by issuers of corresponding accounts (or by parties on behalf of the issuers). Further, processing networks also often provide enhanced authentication techniques in processing transactions, via utilization of the 3-D Secure™ specification, which relies on 3DS Server software (or merchant plugins (MPIs)) at first parties involved in the transactions and on access control servers (ACSs) associated with the issuers to perform such authentication. In connection therewith, the 3-D Secure™ specification is also known to be used for certain transactions.

### DRAWINGS

The drawings described herein are for illustrative purposes only of selected embodiments and not all possible implementations, and are not intended to limit the scope of the present disclosure:

FIG. 1 illustrates an example system for use in verifying attributes of users in connection with network interactions involving the users;

FIG. 2 is a block diagram of an example computing device that may be used in the system of FIG. 1;

FIG. 3 illustrates an example method that may be implemented via the system of FIG. 1, for verifying an age attribute, for instance, of a user involved in a network interaction, through use of enhanced authentication.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Accounts are implemented by users to fund interactions for products (e.g., goods, services, etc.) at first parties (e.g., merchants, etc.). To avoid issues related to use of the accounts, issuers of the accounts may impose authentication and validation techniques and/or requirements for the users initiating the transactions. In connection with enhanced authentication, via the 3-D Secure™ specification, for instance, the result of the authentication may not be linked to authorization for the transactions. Such enhanced authentication of the users is limited to verifying proper or permitted users, or at least the probability of such users. The inventors hereof have recognized the deficiency of the enhanced authentication scheme in that the scheme limits access to data known to the parties involved. However, the inventors have also recognized that use of such known data may provide for additional verification of specific attributes of the users, such as, for example, age.

Uniquely, the systems and methods herein provide for verifying an age attribute of a user involved in a network interaction, through use of enhanced authentication schemes.

In particular, in one example implementation of the present disclosure, in connection with a network interaction by a user, a first party includes an age verification signal in an authentication request, which may include simply an age verification/indication, or a verification related to a specific threshold (e.g., older than twenty-one years of age, etc.). The enhanced authentication scheme, or parts thereof, cooperate to retrieve birthdate information related to the user and to provide the specific age verification indicated in the verification signal. In this manner, the enhanced authentication scheme is leveraged to extend the functionality thereof to verify age attributes, without additional friction with the user at the first party. As such, the first party is alleviated from presenting documentation of age to a scheme, which already has access to such verifiable information as a mechanism to provide efficiencies in both verification and authentication as part of a transaction.

It should be understood that while the embodiments herein are described with reference to verifying age, other attributes of personal identifying data may be verified through the steps and/or operations described herein. For example, the verification may extend to height, weight, citizenship, country of origin, reward/loyalty status, medical status (e.g., vaccination, etc.), insurance status, name, employment status, residence information (e.g., residential address, country of residence, state of residence, city of residence, etc.), etc. In connection therewith, the source of the attribute(s) may include an issuer of an account (e.g., a financial account, payment account, etc.) of the user, a data repository (e.g., identity provider, employer, government entity, insurance company, etc.), or other suitable source, etc. Consistent therewith, the description below is not limited to birthdate or age, and should be understood to be applicable to such attribute(s) in lieu of birthdate or age (as if described with reference to such attribute(s)).

It should also be understood that while the embodiments herein are generally described with reference to purchase transactions, the attribute verification features of the present disclosure may similarly be provided and/or implemented as part of a non-purchase interactions (e.g., as part of age verification to access certain web content or certain websites, etc.). Such access verification may follow, for example, the 3-D Secure™ protocol/specification flow, as described herein, but utilize a distinct message category to differentiate the non-purchase interactions from purchase transactions (e.g., message category=02 for non-purchase interactions versus message category=01 for purchase transactions, etc.) and/or utilize a zero dollar transaction for the non-purchase interactions.

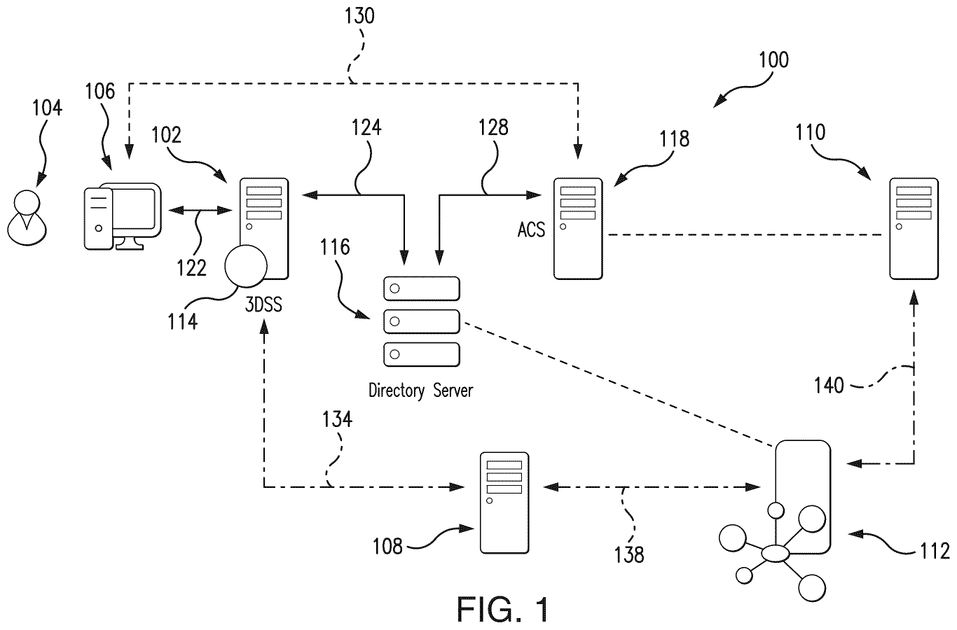

FIG. 1 illustrates an example system 100 for verifying an age attribute of a user 104 in connection with an interaction or transaction by the user 104 at a merchant 102, and which is consistent with the EMV® 3-D Secure™ protocol/specification, for example. It should be appreciated, however, that not all details of the EMV® 3-D Secure™ protocol/specification are discussed herein, as such information is readily understood by those skilled in the art. In addition, the illustrated system 100 includes a plurality of entities that interact with each other by exchanging multiple, specifically formatted messages over secure communication channels (e.g., as defined in the EMV® 3-D Secure™ protocol/specification (see, e.g., https://www.cmvco.com/emv-technologies/3d-secure/; etc.), etc.). Accordingly, it should be appreciated that the example system 100 illustrated in FIG. 1 is complex, given the number and extent of entities, messages, and other requirements necessarily involved.

As shown in FIG. 1, the system 100 includes the merchant 102, the user 104 who, in this example, interactions with the merchant 102 for one or more products, and a computing device 106 associated with the user 104. That said, as noted above, in other examples, the user 104 may interact with the merchant 102 independent of purchasing any products while still invoking the verification features described herein (e.g., the user 104 may interact with the merchant 102, or more broadly, first party, to gain access to content and/or services provided by the first party that is age restricted, etc.).

The merchant 102 includes, in this example embodiment, a virtual merchant having a virtual merchant location, such as, for example, a website, a network-based application, etc., which is accessible by users (e.g., the user 104, etc.), via a computing device (e.g., the computing device 106 associated with the user 104, etc.). The merchant virtual location may be managed and/or provided directly by the merchant 102, or it may be managed and/or provided by another entity on behalf of the merchant 102, etc. In general, the merchant virtual location permits the user 104 to browse and/or search among one or more products (e.g., good, services, etc.) and to select product(s) for purchase from the merchant 102 (e.g., as part of an e-commerce interaction, as part of a card-not-present interaction (e.g., token-based interaction, etc.), etc.). In addition, in this example embodiment, the merchant 102 may include a physical brick-and-mortar location, at which the user 104 may also physically enter to browse and/or search among one or more products (e.g., good, services, etc.) and to select product(s) for purchase from the merchant 102.

The computing device 106 may include, for example, a tablet, a smartphone, a laptop, a desktop, or other device, which enables the user 104 to interact and/or communicate with the merchant virtual location.

In this example embodiment, the merchant 102 is associated with an acquirer 108 (e.g., including an acquirer computing device, etc.), in that the acquirer 108 issues an account to the merchant 102 to receive funds in connection with payment account transactions directed toward the merchant 102. Likewise, the user 104 is associated with an issuer 110, in that the issuer 110 has issued an account (e.g., a credit account, a debit account, a prepaid account, etc.) to the user 104 to fund interactions directed toward the merchant 102 (and other merchants) for the purchase of one or more products. The system 100 also includes a processing network 112, which is configured to coordinate between the acquirer 108 and the issuer 110 to transfer funds, consistent with an authorization to transfer such funds through clearing and/or settlement therebetween. Authorization of a transaction (broadly, an interaction) between the user 104 and the merchant 102 is described in more detail below.

The system 100 as shown in FIG. 1 also implements the 3-D Secure™ specification (as part of enhanced authentication of transactions). In connection therewith, the system 100 further includes a merchant plug-in (MPI) 114, a directory server 116, and an access control server (ACS) 118, which are configured to cooperate to provide enhanced authentication of the user 104 in the context of an interaction at the merchant 102, as described more below. The MPI 114 is associated with and/or is included in the merchant 102, and/or executed by a computing device of the merchant 102. That said, while the merchant 102 includes the MPI 114, it should be appreciated that the MPI 114 may be one or more separate servers and/or services, which are associated with the merchant 102, yet suitable to participate in the enhanced authentication described herein, or otherwise.

The ACS 118 is associated with the issuer 110, or on behalf of the issuer 110, for example, as defined by the 3-D Secure™ specification (as generally indicated by the dotted line in FIG. 1). While illustrated apart from the issuer 110 in FIG. 1, it should be appreciated that the ACS 118 may be included in the issuer 110 in other embodiments. And, the directory server 116 may be part of the processing network 112 (as indicated by the dotted line in FIG. 1), or separate therefrom, yet coupled in communication therewith. It should be appreciated that each of the MPI 114, the directory server 116, and the ACS 118 may be standalone computing devices, or may be integrated, in whole or in part, with one or more computing device(s) deployed at the merchant 102 (e.g., a POS terminal or backend, etc.), the issuer 110, and/or the processing network 112, etc. It should also be appreciated that the system 100 may implement other authentication specifications in other embodiments.

The parts of system 100 are coupled in communication through one or more networks, whereby messaging (e.g., requests, replies, responses, etc.), as described herein (and indicated by arrowed lines), are permitted.

The network(s) may each include, without limitation, one or more local area networks (LANs), wide area networks (WANs) (e.g., the Internet, etc.), mobile networks, virtual networks, other networks as described herein, and/or other suitable public and/or private networks capable of supporting communication among two or more of the illustrated parts, or even combinations thereof. In one example, a network includes multiple networks, where different ones of the multiple networks are accessible to different ones of the illustrated components in FIG. 1. For instance, the processing network 112, the acquirer 108, and issuer 110 may be connected via a private network and, separately, the merchant 102 and the computing device 106 of the user 104 may be connected through a public network, such as the Internet.

In connection with the above, the merchant 102 sells and offers for sale one or more products, which are age restricted. For example, where the merchant 102 sells alcoholic beverages, the merchant 102 is required, in connection with the purchase, to verify the age of the user 104, and more specially, verify the age of the user 104 is at or above a legal threshold for the purchase of alcoholic beverages. Other age restrictions may be associated with various other products, which may include, without limitation, gambling, rentals (e.g., car rentals, scooter rentals, etc.), etc.

Upon deciding on a purchase, the user 104 requests to purchase a product, which is age restricted, and provides account data for the account to fund the interaction. In connection with an interaction by the user 104 at the virtual location of the merchant 102, this may include providing an account number to an interface at the user's computing device 106 (e.g., as part of a card-not-present transaction, etc.). Alternatively, in connection with an interaction by the user 104 at the physical location of the merchant 102, this may involve swiping, tapping, inserting, etc., a card at a terminal of the merchant 102, etc.

In either case in this embodiment, in response, the MPI 114 associated with the merchant 102 is configured to compile an authentication request (AReq) for the interaction. The authentication request includes an age verification signal or data element, which indicates an age verification request, and potentially, an age threshold for the product (e.g., eighteen, twenty-one, twenty-five years of age, etc.). In one or more embodiments, the age verification signal is a message extension, populated into a custom signal space of the AReq (e.g., as defined in the EMV 3DS™ specification, etc.), where the age verification signal includes, without limitation, a name (e.g., Age Verification Request, etc.), an ID (e.g., 001-age-verification, etc.), an indicator (e.g., a criticality_indicator such as false, true, etc.), and desired data (e.g., minimum-required-age: 21, etc.), etc. The AReq further includes, without limitation, a merchant name for the merchant 102, a merchant ID for the merchant 102, the payment account credential (e.g., the PAN, the token, etc.) for the user's payment account, an amount, a currency code, etc. What's more, the AReq is provided/configured to include many different data elements, which may include mandatory, conditional, or optional elements, for example, as defined and/or suggested by the EMV 3DS™ specification, etc.

The MPI 114 is configured to then transmit the AReq, via path 124, to the directory server 116. Upon receipt of the AReq (with the age verification signal), the directory server 116 is configured to then provide, for example, the AReq, with the account number and data, via path 128, to the ACS 118.

The ACS 118, in turn, is configured to recognize the age verification signal and to verify that the age of the user 104 is consistent with a threshold (e.g., included in the age verification signal, or otherwise, etc.). In connection therewith, the ACS 118 is configured to access birthdate attributes for the user 104, as defined by the issuer 110, for example, from a profile for the user 104 at the issuer 110 (e.g., as generated by the user 104 when establishing his/her account with the issuer 110, etc.) and/or from a data repository for such attributes (e.g., identity provider, employer, government entity, insurance company, etc.). The ACS 118 is configured to define an age for the user 104 based on the birthdate of the user 104, as accessed, and a current date and then to compare the age to the threshold.

When the age does not satisfy the threshold or when required data to perform the verification is not available (e.g., birthdate attributes are not available for the user 104, etc.), the ACS 118 is configured to compile a negative/decline authentication response (ARes) for the interaction. The negative/decline authentication response may indicate a reason and/or code for the message. In particular, the ARes may indicate that the age verification failed due to age (e.g., the user is not old enough, etc.), or potentially, that the age verification failed due to the birthdate being “unavailable,” etc.

Conversely, when the age satisfies the threshold, the ACS 118 is configured to provide an instruction for a challenge question or step up, consistent with conventional techniques, to require a biometric authentication of the user 104. While a biometric challenge is included in this example embodiment, it should be appreciated that other types of challenges, which do not rely on biometrics, may be available and/or suitable, for example, depending on the reason for the age verification, applicable rules/regulations, etc. In one embodiment, the challenge may be based on any type of authentication that is strong customer authentication (SCA) compliant (e.g., as defined by the EU Revised Directive on Payment Services (PSD2), etc.) and/or that is provided by and/or available to the ACS 118. In any case, in connection with the challenge, the ACS 118 is configured to return, as part of the ARes, a URL which is specific to the ACS 118.

In particular, the ACS 124 may be configured to include a challenge indicator (e.g., a network address to be called by the merchant 102, etc.) in the ARes and then transmit the ARes to the directory server 116, along path 128. Here, the directory server 116 may be configured to then transmit the ARes to the MPI 114, via path 124. In turn, the MPI 114 is configured to identify the challenge indicator and to call or otherwise invoke the challenge, thereby providing interaction, via path 130, between the user's computing device 106 (e.g., via a browser or an application therein, etc.) and the ACS 118. In connection therewith, the MPI 114 may identify the user's computing device 106 based on the original interaction between the user 104 and the virtual location of the merchant 104, or based on an address for the computing device 106 retrieved by the ACS 124 from the profile of the user 104 at the issuer 110 and returned to the MPI 114 as part of the ARes (e.g., for an interaction by the user 104 at the physical location of the merchant 104, etc.), etc.). Alternatively, in other example embodiments, the MPI 114 may identify a terminal of the merchant 104 for such interaction with the ACS 118, to facilitate the challenge.

The challenge interaction generally includes the presentation of a biometric challenge question or instruction (e.g., “Provide your Fingerprint,” etc.) to the user 104, for example, at the user's computing device 106 in this example or, in other example embodiments, at the terminal of the merchant 104, whereupon the user 104 provides a response (i.e., a biometric input), via path 130. And, the ACS 118 is configured to confirm the biometric input of the user 104 with a biometric repository associated with the ACS 118 and/or the issuer 110. In general, the confirmation may include a matching of the biometric input to a biometric reference, which was previously associated and/or verified to the user 104. Thereafter, when the biometric input is confirmed, the ACS 118 is configured, consistent with the above, to generate a challenge response and to transmit the challenge response to the directory server 116, via path 128.

Upon receipt of the challenge response (indicative of the biometric confirmation), the directory server 116 is configured to compile an accountholder authentication value (AAV) and to provide the AAV to the MPI 114, again via path 124. At this point, the merchant 102 is informed that the age verification is successful, whereby purchase of the product(s) is permittable. What's more, the age verification is completed with the birthdate of the user 104 not being shared with the merchant 102. In this way, the merchant 102 is only informed of the specific qualification of the user 104 to purchase the product, and not the particular age or birthdate of the user 104, i.e., information that the merchant 102 does not need.

In turn, given the age verification, the merchant 102 is configured to compile an authorization request for the transaction, which includes the account number for the user's payment account (broadly, an account identifier for the user's account), as appropriate, and also the AAV and potentially, a discrete indication of a successful age verification. Once compiled, the merchant 102 is configured to then transmit the authorization request to the acquirer 108, via path 134. The acquirer 132, in turn, is configured to transmit the authorization request to the processing network 112, via path 138.

Upon receipt of the authorization request, the processing network 112 is configured to perform an authentication verification on the transaction, whereby the prior authentication for the transaction is identified to and/or matched with the authorization (when such prior authentication is completed for the transaction). In connection therewith, the processing network 112 is configured to transmit the authorization request (along with an authorization verification response/result) to the issuer 110 (e.g., as added to the authorization request by the processing network 112, etc.). In this manner, the issuer 110 is informed of the details of association between the authentication of the user 104 (if any) and the authorization being sought by the merchant 102 for the given transaction. And, the issuer 110 may then utilize the authorization verification response/result as part of determining whether to approve or decline the given transaction, as is conventional.

In various example embodiments, the directory server 116 may be configured to perform the age verification, prior to advancing the AReq to the ACS 118. In particular, the directory server 116 may be configured to identify the age verification signal in the AReq and to verify the age of the user 104, based on data included in the directory server 116 and/or accessible to the directory server 116. That is, the directory server 116 may be configured to access birthdate attributes for the user 104, as defined by the issuer 110 or otherwise, in a data structure accessible to the directory server 116. The directory server 116 is configured to define an age for the user 104 based on the birthdate of the user 104 and a current date and then to compare the age to the threshold (e.g., as indicated in the age verification signal, etc.).

When the age does not satisfy the threshold, the directory server 116 is configured to compile a negative/decline authentication response (ARes) for the interaction and to return the ARes to the MPI 114, whereupon the interaction is declined by the merchant 102.

Conversely, when the age satisfies the threshold, the directory server 116 is configured to provide the AReq to the ACS 118, whereby the ACS 118 is configured to require a challenge question or step up, consistent with conventional techniques, to require a biometric authentication of the user 104 in order to complete the age verification of the user 104, as described above.

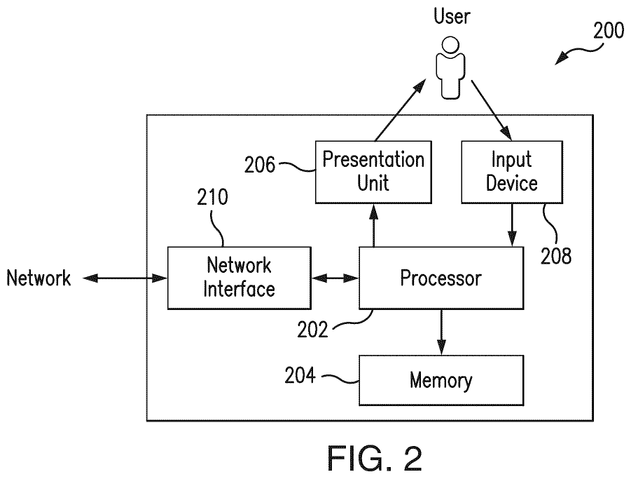

FIG. 2 illustrates example computing device 200, which may include, for example, one or more servers, workstations, personal computers, laptops, tablets, smartphones, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In at least one embodiment, the computing device 200 is accessed (for use as described herein) as a cloud, fog and/or mist type computing device. With that said, the system 100 should not be considered to be limited to the computing device 200, as described below, as different computing devices and/or arrangements of computing devices may be used. In addition, different components and/or arrangements of components may be used in other computing devices.

It should be appreciated that each of the merchant 102, the computing device 106, the acquirer 108, the issuer 110, the processing network 112, the MPI 114, the directory server 116, and the ACS 118, etc., in the system 100 are implemented herein in one or more computing devices, such as computing device 200 illustrated in FIG. 2. In connection therewith, the one or more computing devices are each in communication with one or more other entities via at least one of the networks described herein. In general, each of the paths included in FIG. 1, along which, or via which, messages are exchanged in the above description, are representative of the network(s).

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permits data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, age verification signals, birthdates, transaction IDs, account numbers (e.g., PANs, etc.), and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 and/or other computer system components configured to perform one or more of the various operations herein, and may effectively transform the computing device 200 into a special purpose computing device. It should be appreciated that the memory 204 may include a variety of different memories, each implemented in one or more of the functions or processes described herein.

In the example embodiment, the computing device 200 also includes a presentation unit 206 that is coupled to the processor 202 (however, it should be appreciated that the computing device 200 could include output devices other than the presentation unit 206, etc.). The presentation unit 206 outputs information (e.g., confirmations of purchases, challenge questions, etc.), either visually or audibly to the user 104 or other information to other users associated with any of the entities illustrated in FIG. 1, at a respective computing device, etc. It should be further appreciated that various interfaces may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

In addition, the computing device 200 includes an input device 208 that receives inputs from users (i.e., user inputs) such as, for example, responses to challenge questions, checkout inputs, payment account credentials, etc., from the user 104 or other information from other users in the system, etc. The input device 208 may include a single input device or multiple input devices. The input device 208 is coupled to (and is in communication with) the processor 202 and may include, for example, one or more of a keyboard, a pointing device, a mouse, a touch sensitive panel (e.g., a touch pad or a touch screen, etc.), another computing device, and/or an audio input device. Further, in various example embodiments, a touch screen, such as that included in a tablet, a smartphone, or similar device, may behave as both the output device 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks and/or one or more other computing devices herein.

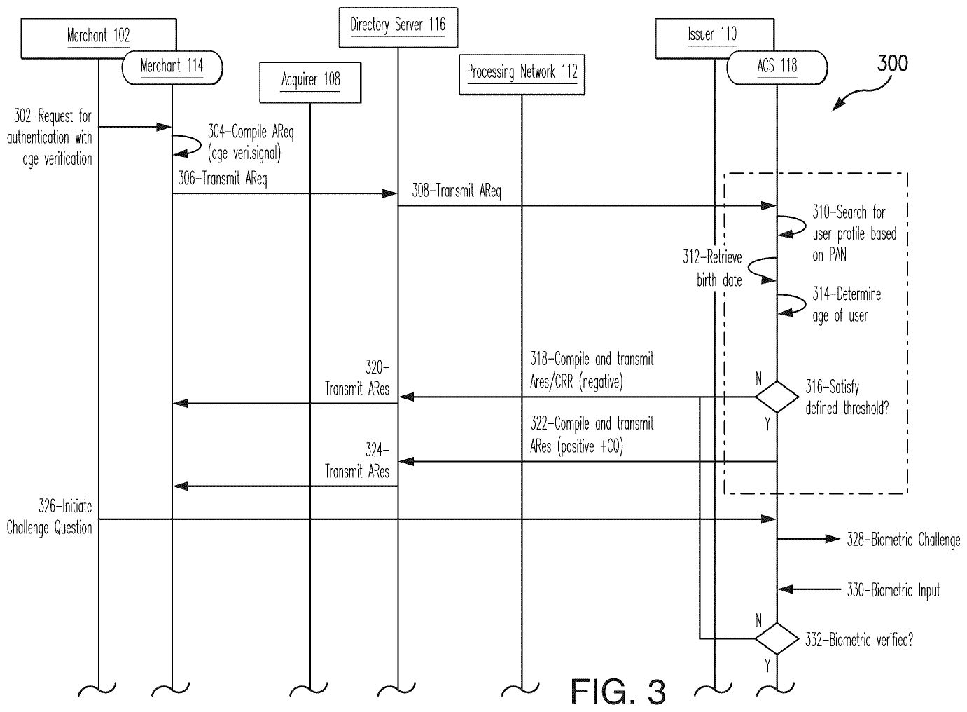

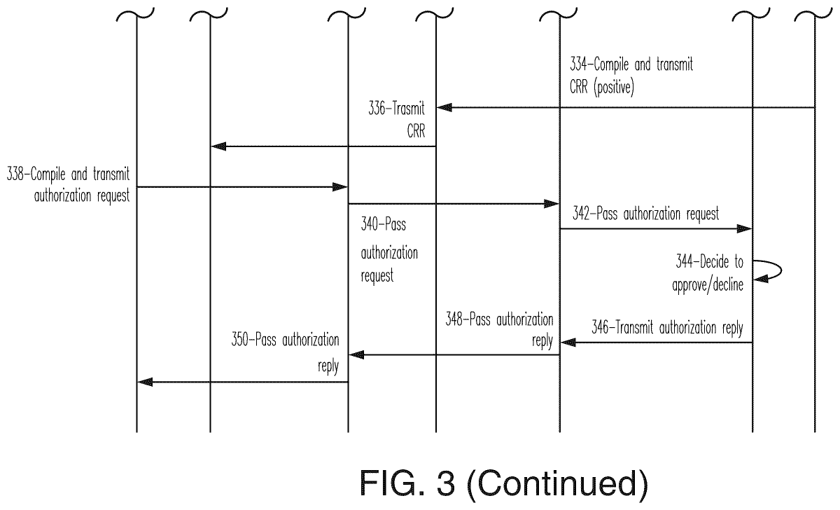

FIG. 3 illustrates an example method 300 for use in verifying the age of a user in connection with a network interaction. The example method 300 is described (with reference to FIG. 1) as generally implemented in the MPI 114, the directory server 116, and the ACS 118, and more generally, in the system 100, and with further reference to the computing device 200. As should be appreciated, however, the methods herein should not be understood to be limited to the example system 100 or the example computing device 200, and the systems and the computing devices herein should not be understood to be limited to the example method 300.

In the illustrated method 300, for an interaction initiated by the user 104 with the merchant 102, for an age restricted product (e.g., gambling, alcohol, rental service, etc.), the MPI 114 receives an authentication instruction from the merchant 102, at 302. The instruction includes the details of the interaction and also an age verification signal, which includes an age verification indicator and, in this example, a defined threshold for the product to be purchase (e.g., at least eighteen years old, at least twenty-five years old, etc.). It should be appreciated that the age verification signal may not indicate a defined threshold, for example, where age verification is requested by type, which, in turn, is related to a specific age threshold, or where the threshold is a default (e.g., twenty one or older, etc.) unless specified otherwise, etc.

Next, the MPI 114 compiles, at 304, an authentication request (AReq), which includes the details of the transaction and the age verification signal, etc. It should be appreciated that the age verification signal may be compiled at the merchant 102 in other examples, and transmitted to the MPI 114. The MPI 114 further transmits, at 306, the AReq to the directory server 116.

The directory server 116 receives the AReq and transmits, at 308, the AReq to the ACS 118.

In response, the ACS 118 recognizes the age verification signal and determines the age of the user 104. In particular, the ACS 118 searches, at 310, in a database associated with the issuer 110, for example, for a user profile based on the account number included in the AReq. The ACS 118 retrieves, at 312, a birthdate of the user 104 from the user profile identified by the account number. The ACS 118 then determines, at 314, the age of the user 104 based on the birthdate and the current date. The ACS 118 then compares the age of the user to the defined threshold for the product to determine, at 316, whether the user 104 is old enough to purchase the age restricted product at the merchant 102. The defined threshold may be included in the AReq, as part of the age verification signal, or the defined threshold may be a default (e.g., based on the merchant 102 or a type of the merchant 102, etc.).

When the age fails to satisfy the defined threshold, the ACS 118 compiles, at 318, and transmits an authentication response or ARes, which includes a decline or negative response that indicates the age verification is failed, to the directory server 116. The directory server 116 then transmits, at 320, the ARes back to the MPI 114, whereupon the merchant 102 declines or ends the interaction, because the user 104 is not permitted to purchase the age restricted product(s).

When the age satisfies the defined threshold, the ACS 118 compiles and transmits, at 322, the ARes, which includes an approve or positive response that indicates the age verification is successful, to the directory server 116. The ARes further indicates an indication of a challenge question or CQ, as an indicator of a requirement for a biometric authentication of the user 104 in this example. The directory server 116 then transmits, at 324, the ARes back to the MPI 114.

In response the merchant 102 (and/or MPI 114) initiates a challenge question, at 326, whereby the computing device 106 of the user 104 is connected, via a website or other network connection, with the ACS 118 (e.g., via the user's device 106 and a corresponding URL for the ACS 118, etc.). At 328, the ACS 118 issues a biometric challenge (broadly, challenge) to the user 104 (e.g., at the user's device 106, etc.). The biometric challenge may be a request for the user 104 to capture a facial image or other biometric, via the computing device 106 (e.g., a smartphone, etc.). In response, the user 104 provides a biometric input to the computing device 106, for example, which in turn, at 330, provides the biometric input to the ACS 118. The ACS 118 then determines, at 332, whether the user 104 is verified and/or authenticated based on the biometric.

It should be appreciated that while a biometric challenge is referenced herein, in one or more embodiments, a non-biometric challenge may be accepted, whereby a passcode, a one-time passcode (OTP), or acknowledgement at the computing device 106 may be sufficient to support the age verification.

As shown in FIG. 3, when the user 104 is not verified and/or authenticated based on the biometric, the method 300 proceeds to step 318, where the ACS 118 compiles and transmits a challenge result response (CRR), which includes a decline or negative response that indicates the age verification is failed, to the directory server 116. The directory server 116 then transmits, at 320, the CRR back to the MPI 114, whereupon the merchant 102 declines or ends the interaction, because the user 104 is not permitted to purchase the age restricted product(s).

When the age satisfies the defined threshold, the ACS 118 compiles and transmits, at 334, the CRR, which includes an approve or positive response that indicates the age verification is successful, to the directory server 116. The directory server 116 then transmits, at 336, the CRR back to the MPI 114, whereupon the merchant 102 is permitted to proceed to authorize the interaction (i.e., proceeds when the age verification is successful).

At 338, the merchant 102 compiles and transmits an authorization request to the acquirer 108. The authorization request includes the transaction details (e.g., amount, account number, etc.) and an AAV received from the MPI 114, as compiled at the directory server 116 and/or the ACS 118 based on the successful challenge. The authorization request may further include a discrete indication of a successful age verification. And, in turn, the acquirer 108 transmits, at 340, the authorization request to the processing network 112.

Upon receipt of the authorization request, the processing network 112 perform authentication validation for the interaction, based on the content of the authorization request (e.g., an AAV based on the interactions of the MPI 114, the directory server 116, and the ACS 118, etc.). When validated, the processing network 112 in turn transmits the authorization request to the issuer 110, at 342.

In response, at 344, the issuer 110 determines whether to approve or decline the interaction. Thereafter, the issuer 110 compiles an authorization response for the interaction and transmits the authorization response, at 346, back to the processing network 112. The processing network 112 then transmits, at 348, the authorization response to the acquirer 108, and the acquirer 108 transmits, at 350, the authorization reply to the merchant 102. The merchant 102, depending on the result, may then deliver the product to the user 104, or seek alternate funding for the transaction, depending on the approval or decline of the transaction by the issuer 110.

It should be appreciated that in FIG. 3, the ACS 118 performs the age verification of the user 104, based on the user profile and the birthdate included therein. The age verification of the user 104 is designated, in part, in the dotted box in FIG. 3. It should be appreciated that in one or more alternate method embodiments, the directory server 116 may perform the age verification based on the user profile being accessible to the directory server 116. In such embodiment, the directory server 116 may omit interaction with the ACS 118, for the specific interaction, when the age verification fails.

While age verification of the user 104 in the method 300 is described with reference to a purchase transaction by the user 104 at the merchant 102, it should be appreciated that verification of an age of the user 104 (or other attribute) may be performed as part of a non-purchase interaction in other example embodiments. Such verification may follow, for example, the 3-D Secure™ protocol/specification flow, as described above, but utilize a distinct message category to differentiate the non-purchase interactions from purchase transactions (e.g., message category=02 for non-purchase interactions versus message category=01 for purchase transactions, etc.) and/or utilize a zero dollar transaction for the non-purchase interactions.

In view of the above, the systems and methods and computer-readable storage media herein uniquely provide for age verification for users in connection with the purchase of age restricted products. In this way, the network traffic, and physical presentment of documents is reduced and/or eliminated. What's more the disclosure of unrelated personal identifying information (e.g., when presenting a driver's license with attribute information beyond birthday (or age), etc.), whereby the systems and method herein may uniquely provide for enhanced security.

In one general embodiment, a computer-implemented method is provided for verifying one or more attributes of users. The method includes receiving, at a computing device, an authentication request (AReq), in connection with an interaction related to a product, the AReq including an account number for a user and an attribute verification signal; in response to the attribute verification signal: retrieving, by the computing device, attribute data for the user; determining, by the computing device, based on the attribute data of the user, the one or more attributes of the user; and determining, by the computing device, the one or more attributes of the user satisfies a condition (e.g., a threshold, status, etc.); and in response to the one or more attributes of the user satisfying the condition, causing a challenge question to be issued to the user, whereby authentication of the user is initiated through a mobile device of the user.

In the embodiment above, the one or more attributes may include name, citizenship immigration status, birthdate, etc., and the computing device may include an access control server (ACS), which is disposed in communication with a directory server of an enhanced authentication scheme in connection with the interaction related to the age-restricted product. Also, the condition may includes a specific, required or expected citizenship or immigration status. Also, it should be understood that retrieving the attribute data for the user may include retrieving the attribute data for the user from the user profile.

The above embodiment may further be provided in the form of a system or a non-transitory computer-readable storage media, in lieu of a method in other embodiments.

Again, and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations as recited herein and/or in the following claims, including, for example (and without limitation): (a) receiving an authentication request (AReq), in connection with an interaction related to an age-restricted product, the AReq including an account number for a user and an age verification signal; (b) in response to the age verification signal: (i) retrieving a birthdate of the user; (ii) determining, based on the birthdate of the user, an age of the user; and (iii) determining the age of the user satisfies a defined threshold; (c) in response to the age of the user satisfying the defined threshold, causing a challenge question to be issued to the user, whereby authentication of the user is initiated through a mobile device of the user; (d) searching for a user profile for the user based on the account number included in the AReq; (c) transmitting a challenge result response to a merchant plugin (MPI) associated with a merchant involved in the interaction; and/or (f) receiving, from the merchant, an authorization request for the interaction to purchase the age-restricted product, based on the challenge result response.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9, and so forth.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for verifying age attributes of users in connection with network interactions involving the users, the method comprising:
receiving, at a computing device, an authentication request (AReq), in connection with an interaction related to an age-restricted product, the AReq including an account number for a user and an age verification signal;
in response to the age verification signal:
retrieving, by the computing device, a birthdate of the user;
determining, by the computing device, based on the birthdate of the user, an age of the user; and
determining, by the computing device, the age of the user satisfies a defined threshold; and
in response to the age of the user satisfying the defined threshold, causing a challenge question to be issued to the user, whereby authentication of the user is initiated through a mobile device of the user.

2. The computer-implemented method of claim 1, wherein the computing device is an access control server (ACS), which is disposed in communication with a directory server of an enhanced authentication scheme in connection with the interaction related to the age-restricted product.

3. The computer-implemented method of claim 2, wherein the age verification signal includes an instruction to verify the age of the user and the defined threshold.

4. The computer-implemented method of claim 3, further comprising searching for a user profile for the user based on the account number included in the AReq; and
wherein retrieving the birthdate for the user includes retrieving the birthdate for the user from the user profile.

5. The computer-implemented method of claim 1, wherein the computing device is a directory server in communication with an access control server (ACS) of an enhanced authentication scheme; and
wherein causing the challenge question includes transmitting the AReq to the ACS, whereby the ACS initiates the challenge question through an authentication response (ARes) back to the directory server.

6. The computer-implemented method of claim 1, wherein the defined threshold is a default, which is not included in the age verification signal.

7. The computer-implemented method of claim 1, further comprising:
transmitting a challenge result response to a merchant plugin (MPI) associated with a merchant involved in the interaction; and
receiving, from the merchant, an authorization request for the interaction to purchase the age-restricted product, based on the challenge result response.

8. The computer-implemented method of claim 1, wherein receiving the AReq includes receiving the AReq from a directory server; and
wherein retrieving the birthdate includes retrieving the birthdate from a user profile from an issuer of an account identified by the account number; and
wherein causing the challenge question includes including a challenge question indicator in an authentication response (ARes) and transmitting the ARes to the directory server, whereby the directory server transmits the ARes to a merchant plug-in (MPI) to initiate the challenge question with the user.

9. The computer-implemented method of claim 8, wherein the MPI is associated with a merchant involved in the interaction; and
wherein causing the challenge question includes causing the challenge question to be presented to the user, via the merchant.

10. A system for verifying age attributes of users in connection with network interactions involving the users, the system comprising:
an access control server (ACS), which is configured, by executable instructions, to:
receive an authentication request (AReq), in connection with an interaction related to an age-restricted product, the AReq including an account number of an account of a user and an age verification signal;
in response to the age verification signal:
retrieve a birthdate of the user, via an issuer of the account to the user;
determine, based on the birthdate of the user, an age of the user; and
determine the age of the user satisfies a defined threshold; and
in response to the age of the user satisfying the defined threshold, cause a challenge question to be issued to the user, whereby authentication of the user is initiated through a mobile device of the user.

11. The system of claim 10, wherein the ACS is coupled in communication with a directory server of an enhanced authentication scheme in connection with the interaction related to the age-restricted product.

12. The system of claim 11, wherein the age verification signal includes an instruction to verify the age of the user and the defined age threshold.

13. The system of claim 12, wherein the ACS, is further configured, by the executable instructions, to search for a user profile for the user based on the account number included in the AReq; and
wherein the ACS is configured, by the executable instruction, in retrieving the birthdate for the user, to retrieve the birthdate for the user from the user profile.

14. The system of claim 10, wherein the defined threshold is a default, which is not included in the age verification signal.

15. The system of claim 10, wherein the ACS is further configured, by the executable instructions, to:
transmit a challenge result response to a merchant plugin (MPI) associated with a merchant involved in the interaction, after authenticating the user, via the challenge question.

16. The system of claim 10, wherein the ACS is configured, by the executable instructions, to receive the AReq from a directory server; and
wherein the ACS is configured, by the executable instructions, in retrieving the birthdate, to retrieve the birthdate from a user profile from an issuer of an account identified by the account number; and
wherein the ACS is configured, by the executable instructions, in causing the challenge question, to includes a challenge question indicator in an authentication response (ARes) and to transmit the ARes to the directory server, whereby the directory server transmits the ARes to a merchant plug-in (MPI) to initiate the challenge question with the user.

17. The system of claim 16, wherein the MPI is associated with a merchant involved in the interaction; and
wherein the ACS is configured, by the executable instructions, in causing the challenge question, to cause the challenge question to be presented to the user, via one of an application and a browser included in the mobile device.

18. A non-transitory computer readable storage medium including executable instructions for verifying one or more attributes of a user in connection with a network interaction involving the user, wherein when the executable instructions are executed by at least one processor of a payment network, the executable instructions cause the at least one processor to:
receive an authentication request (AReq) in connection with an interaction by a user with a merchant, the AReq including an account number of an account of a user and a verification signal;
in response to the verification signal:
retrieve an attribute of the user, via an issuer of the account to the user; and
determine the attribute of the user satisfies a defined threshold; and
in response to the attribute of the user satisfying the defined threshold, cause a challenge question to be issued to the user, whereby authentication of the user is initiated through a mobile device of the user.
